(19) United States
(12) Patent Application Publication
(10) Pub. No.: US 2008/0148160 A1
(43) Pub. Date: Jun. 19, 2008

(54) BITMAP BASED APPLICATION SHARING ACCESSIBILITY FRAMEWORK

(76) Inventors: Carolyn J. Holmes, Georgetown, KY (US); John B. O'Nan, Lexington, KY (US); Andrew M. Ortwein, Lexington, KY (US); William M. Quinn, Lexington, KY (US); Amy D. Travis, Arlington, MA (US)

Correspondence Address: HOFFMAN, WARNICK & D'ALESSANDRO LLC, 75 STATE STREET, 14TH FLOOR, ALBANY, NY, 12207, US

(21) Appl. No.: 11/612,759

(22) Filed: Dec. 19, 2006

(51) Int. Cl. G06F 3/00; G06F 15/173; G06F 15/16

(52) U.S. Cl. 715/758; 709/223; 709/217

(57) ABSTRACT

A method and mechanism captures the text that is associated with the screen image displayed on the host user's computer monitor, and a mechanism for either displaying or reading the shared text on the viewer systems. By adding additional components to a typical application sharing framework, a truly accessible image sharing system can be achieved, and it can allow impaired users to use the assistive technology of their choice.

### FIELD OF THE INVENTION

The invention relates generally to application sharing, and, more particularly, to a system and method for allowing end users, having a disability, such as a visual disability, to have access to an application sharing session.

### BACKGROUND OF THE INVENTION

Application Sharing is an element of remote access that enables two or more users to access a shared application or document from their respective computers simultaneously in real time. Generally, the shared application or document will be running on a host computer, and remote access to the shared content will be provided to other users by the host user.

An example is shown in FIG. 1 as system 100. Application Sharing host 102 shares an application 121 with other computers such as Application Sharing Viewer 106. Application Sharing Server 104 may serve the shared application 121 to the other viewers. Application Sharing Host 102 generally has a Controller 108, an Image Grabber Service Provider Interface 110, and an Image Grabber Service Provider 112.

Image Grabber Service Provider 112 grabs the image 122 of the application 121 and passes the image 122 to the Application Sharing Server 104 through the Image Grabber Service Provider Interface 110 and the Controller 108. The Application Sharing Server 104 passes image 122 to Application Sharing Viewer 106. It is then passed on to an Image Renderer Service Provider 120 through Controller 116 and an Image Renderer Service Provider Interface 118. Image Renderer Service Provider 120 renders, or displays, the image 122 to the viewer.

Image 122 may have many components such as graphics 132 and text 126. This is shown more clearly in FIG. 3 where a corporate Intranet site has a display. The display shows the browser window 122 displaying a web page. Web page has text elements 126 and graphics elements 132. A bitmap or a raster image corresponds bit for bit with an image displayed on a screen, probably in the same format as it would be stored in the display's video memory or maybe as a device independent bitmap. “Human Resources Web Site”, “Medical Benefits”, “Leave of Absence Forms”, “View Your Employment History” is in bit mapped image format as well as in text 126, or character data. (The bit-mapped image format having the other non-text elements as well.)

The least complex application sharing technologies work by capturing and sending a series of images which represent what is displayed on a person's (the host user's) computer monitor. These captured images are then rendered on the viewer's monitor, duplicating what the person sharing is seeing. However, this presents a problem for accessibility.

When a visually impaired person views a bitmap-based application sharing session, their screen reader is unable to determine what the host user is sharing. A screen reader is a software application that attempts to identify and interpret what is being displayed on the screen. This is then presented to a blind user as speech (by text-to-speech) or by driving a braille display. Screen readers are used by people with little or no functional vision and are a form of assistive technology: people with some vision often use screen magnifiers.

Application sharing is an inherently visual technology. Because the text which is visible on the shared screen is in image format, rather than in text or character format, the assistive technologies, such as text-to-speech, on the viewer's computer are unable to read it.

Some application sharing solutions provide a method to allow a designated user to manually translate the content of the application sharing session into a format that is accessible. For example a user can join an associated chat and ‘translate’ the application sharing sessions (i.e., have a sighted user type what they are seeing, so that the typed-in information can be read by the non-sighted user, using a screen reader). This solution requires the person hosting an application sharing session to also have a designated user to translate the session. This presents a problem as it requires a manual process and additional users or user roles.

In view of the foregoing, a need exists to overcome these problems by providing a system and method for an end user to design his or her own workflow or business process for his or her unstructured work and/or processes.

### BRIEF SUMMARY OF THE INVENTION

The system and method of the present invention provides a solution to application sharing, and, more particularly, to a system and method for allowing end users, having a disability, such as a visual disability, to have access to an application sharing session.

In one embodiment of the present invention, the application sharing host comprises a separate image grabber service and a text grabber service. The image grabber service grabs the application screen as an image while the text grabber service grabs the text portion of the application screen.

The application sharing viewer comprises a separate image renderer service and a text renderer service. The image renderer service renders the image data while the text renderer service renders the text data.

This invention specifies a framework that solves the accessibility problem inherent in a bitmap-based application sharing system. The invention suggests a method and mechanism for capturing the text that is associated with the screen image displayed on the host user's computer monitor, and a mechanism for either displaying or reading the shared text on the viewer systems. By adding additional components to a typical application sharing framework, a truly accessible image sharing system can be achieved, and it can allow impaired users to use the assistive technology of their choice. The invention does not specify the technology used by these additional components. Instead, it describes which components are needed and how they work together. This is a new way to use existing technologies.

There are many advantages provided by this invention:
This invention can be easily added to an existing bitmap-based solution, which maintains the light-weight “On Demand” nature of such simple application sharing systems.
   This invention allows text to be captured using a service provider interface. This way, alternate text grabbing technologies can be evolved or added over time. This also allows 3rd party technologies to get integrated and adapted with this technology.
   This invention does not require the host user to install and learn a screen reader system. However, the screen reader on the visually challenged viewer can be utilized.
   By treating the text stream separately from the image stream, this solution allows the viewer to implement a buffer of text strings so that users can asynchronously scroll back.
   Treating the text stream separately also allows the image stream to be ‘turned off’ for viewers who are not interested in receiving the shared images. This decreases the application sharing session's bandwidth. Of course, the text stream could also be turned off for users who aren't interested in the text only view. This invention allows the text to be displayed using a standard text format, which enables the user to enlarge the font, making it easier to read the text. (When bitmap-based text is enlarged, it can become illegible.)
   This approach enables new technologies, such as a translator plug-in that could translate captured text from one language to another. For example, a screen could be shared in English, but a plug-in could be added to translate the captured text to a non-English language.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 is a block diagram showing the application sharing system of the prior art.

FIG. 2 is a block diagram of the system of the preferred embodiment of the present invention.

FIG. 3 is a pictorial showing a display to identify various aspects of the system of the present invention.

FIG. 4, comprising FIGS. 4A, 4B and 4C, is a flow chart illustrating the steps of the method of the present invention.

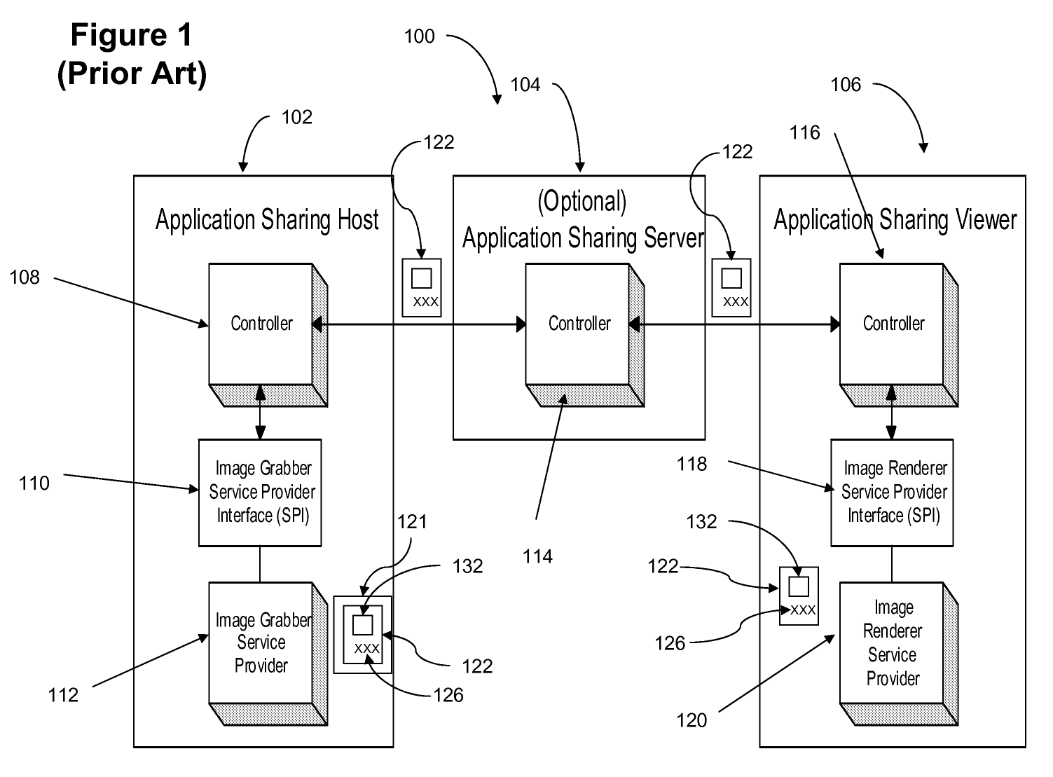

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As used herein, unless otherwise noted, the term “set” means one or more (i.e., at least one) and the phrase “any solution” means any now known or later developed solution. Additionally, the term “data store” means any type of memory, storage device, storage system, and/or the like, which can temporarily or permanently store electronic data, and which can be included in a storage and/or memory hierarchy (collectively referred to herein as a “memory hierarchy”) for a computer system.

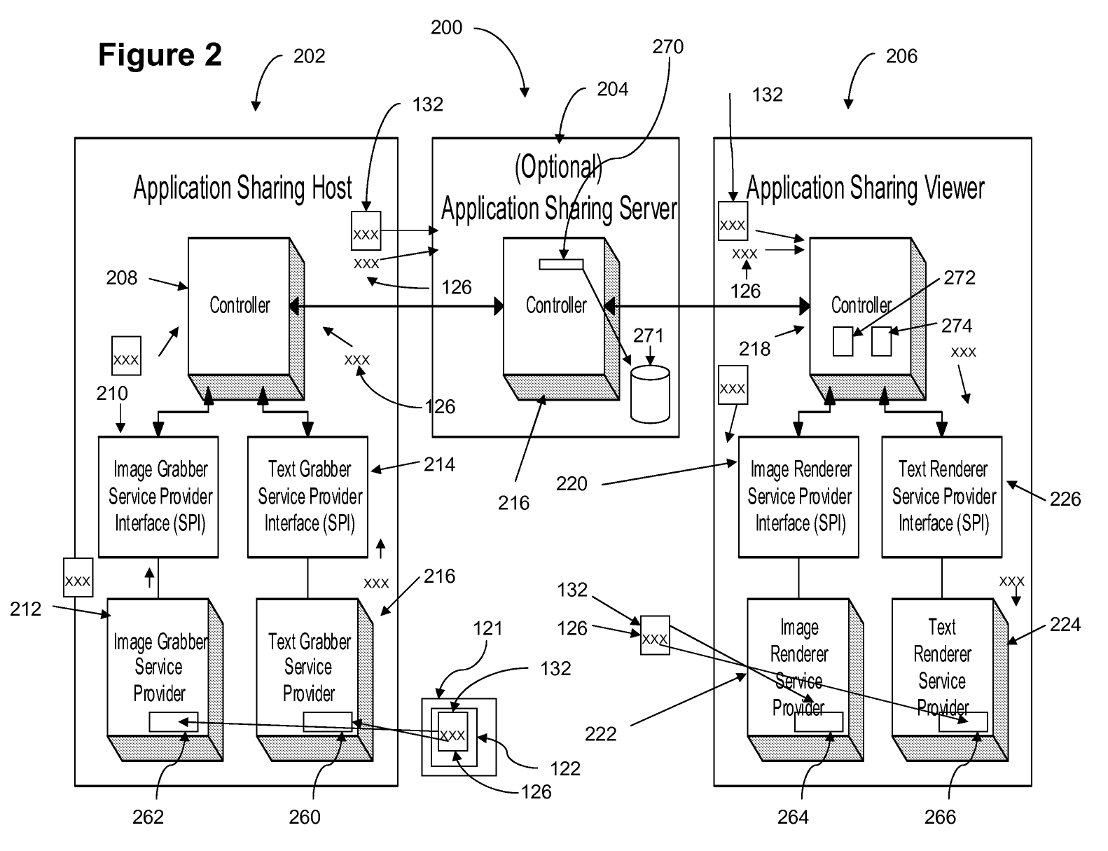

Referring immediately to the figures, in FIG. 2, the system 200 of the present invention is shown. A bitmap-based application sharing session has a host (the machine sharing its screen), or application sharing host 202, one or more viewers (the machines viewing the shared screen), or application sharing viewer 206 and an optional application sharing server 204.

The Application Sharing Host 202 contains code which captures, as a series of Images 132 and Text 126 together as Bit Mapped Graphics 122 and Text 126 by itself, which has been displayed on a host user's computer monitor or Display 121. The Application Sharing Viewer 206 contains code to display the captured Bit Mapped Graphics 132 and captured tText 126.

Application Sharing Host 202 comprises a Controller 208 for sending the Text Data 126 and the Bit Mapped Graphics 132 to Application Sharing Server 204 or directly to Application Sharing Viewer 206. Application Sharing Host 202 further comprises an Image Grabber Service Provider Interface (SPI) 210 for interfacing with an Image Grabber Service Provider 212. The Image Grabber Service Provider, i.e. Plug-in, grabs images of the shared application.

Application Sharing Host 202 further comprises a Text Grabber Service Provider Interface (SPI) 214 for interfacing with a Text Grabber Service Provider 216. The Text Grabber Service Provider, i.e. Plug-in, grabs text off of the shared application.

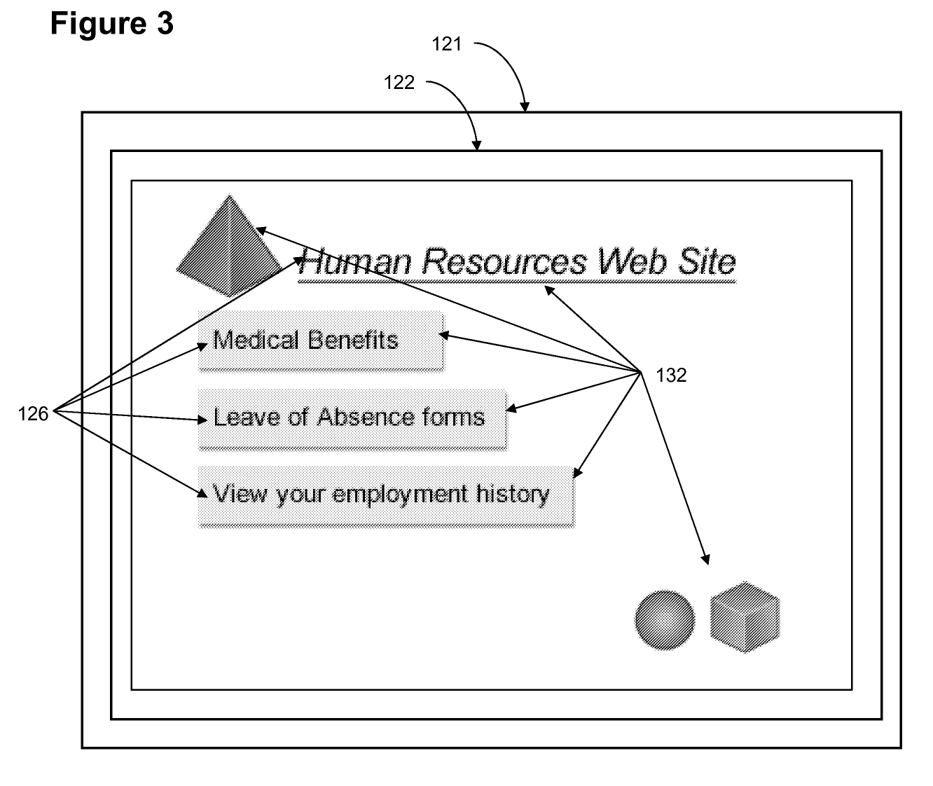

Sharing user's Display 121 can display many types of data—such as Graphical Data 132 and Text Data 126—when Application 122 is operating. This is shown more clearly in FIG. 3. Sharing user's Display 121 has Application 122 operating thereon. Application 122 has Bit Mapped Graphical Image Data 132 and Text Data 126 (Bit Mapped Graphical Image Data 132 comprises Text Data 126 in bit-mapped form.) Other types of data may be used by the Application 122 and displayed on Display 121 as well.

Application Sharing Viewer 206 comprises a Controller 218 for receiving the Text Data 126 and the Image Data 132, as well as any other data, from the Application Sharing Server 204 or directly from Application Sharing Host 202. Application Sharing Viewer 206 further comprises an Image Renderer Service Provider Interface (SPI) 220 for interfacing with an Image Renderer Service Provider 222. The Image Renderer Service Provider, i.e., Plug-in, renders images off of the shared Image Data 132.

Application Sharing Viewer 206 further comprises a Text Renderer Service Provider Interface (SPI) 226 for interfacing with a Text Renderer Service Provider 224. A Text Renderer Service Provider, i.e., Plug-in, renders text off of the shared application.

Sharing user's Display 121 can display many types of data—such as Graphical Data 132 and Text Data 126 (the Text Data sometimes being comprised within the Graphical Date 132)—when Application 122 is operating. This is shown more clearly in FIG. 3. Sharing user's Display 121 has Application 122 operating thereon. Application 122 has Bit Mapped Graphical Data 132 and Text Data 126. As can be seen, the Bit Mapped Graphical Data 132 includes the Text Data 126 but it is saved in bit-mapped form. In accordance with the present invention, the Bit Mapped Graphical Data 132 includes the Text Data 126 in bit-map form but, in addition, a separate data stream from the Bit Mapped Graphical Data stream, in text form, comprises the Text Data 126. Other types of data may be used by the Application 122 and displayed on Display 121 as well.

As shown in FIG. 2, when a sharing user is sharing his/her Application 122, Image Grabber Plug-in 262 grabs the Application 122 as Image Data 132 off of the screen (Display 121) or otherwise from the Application 122. The Image Data 132 is passed on by the Image Grabber Service Provider 212 as specified by the Image Grabber Service Provider Interface 210 to the Controller 208 for sending to Application Sharing Viewer 206 via Application Sharing Server 204 which is optional. Application Sharing Viewer 206 passes the Bit Mapped Image Data 132 as specified by the Image Rendering Service Provider Interface 220 to the Image Rendering Service Provider 222. The Image 132 can then be rendered by the Image Rendering Service Provider Plug-in 264.

Likewise, when a sharing user is sharing his/her Application 122, Text Grabber Plug-in 260 grabs the Text Data 126 off of the screen (Display 121) from the Application 122. The Text Data 126 is passed on, as specified by the Text Grabber Service Provider Interface 214 to the Controller 208 for sending to Application Sharing Viewer 206 via Application Sharing Server 204. Application Sharing Viewer 206 passes the Text 126 as specified by the Text Rendering Service Provider Interface 226 to the Text Rendering Service Provider 224. The Text 126 can then be rendered by the Text Rendering Service Provider Plug-in 266.

The Text Grabber Plug-in 260 captures the Text 126 that is displayed on the computer monitor 121. It may capture the Text 126 from the entire desktop or from a subset of the desktop, such as a single application 122 or a frame. The Text Grabber 216 should be considered a service provider interface (SPI), allowing any number of plug-ins to be added. This framework does not limit itself to a single technique for the Text Grabber Plug-in 260, or to a single instance of a Text Grabber Plug-in. More than one Text Grabber Plug-in could be installed, and then the one that is best suited for the data currently being shared could be used. There are several techniques which a Text Grabber plug-in could use to obtain text, including, but not limited to: a local screen reader, an application specific API/hooks, a proprietary string scraper, OCR, text mining, screen scraping, or web scraping.

The captured text 126 that is passed from the Text Grabber Plug-in to the Host Controller 208 should be in a standard text format. The Text Grabber plug-in can either capture the screen text as text, or it can use a translator to translate from voice-to-text, bitmap-to-text, etc.

The Host Controller 208 is responsible for sending the captured text to the Application Sharing Viewers 206 either directly or through a server. The Viewer Controller 218 passes the captured text 126 to the Text Renderer plug-in(s) 266.

The Text Renderer should also be considered a service provider interface (SPI), allowing any number of plug-ins to be added. For example, one plug-in might use voice technology to read the text, while another plug-in might display the text using a standard text format rather than embedding the text in an image.

Application Sharing Server 204 further has a Recording Component 270 for recording all of the transactions made by the Sharing Host 202 for playback later. The file having the transactions may be stored in a local storage area such as Storage 271. Of course, the Recording Component 270, as well as Storage 271, could be located elsewhere within the System.

In the one or more sharing viewers 206, there may be a Text Renderer Switch 272 and a Graphics Image Renderer Switch 274. Of course, these could be located elsewhere in the System. The Text Renderer Switch 272 and Graphics Image Renderer 274 are controlled by Sharing Viewer 206. The Text Renderer Switch 272 and Graphics Image Renderer Switch 274 allow the user to select whether only the text data is rendered, that is, when the Text Renderer Switch 272 is “turned on”, it turns on the Text Renderer and the text is allowed to be rendered, or whether only the image data is rendered, that is, when the Graphics Image Renderer Switch 274 is “turned on”, the graphics images are allowed to be rendered. Of course, when both text and graphics renderers are “turned on”, both text and graphics are rendered.

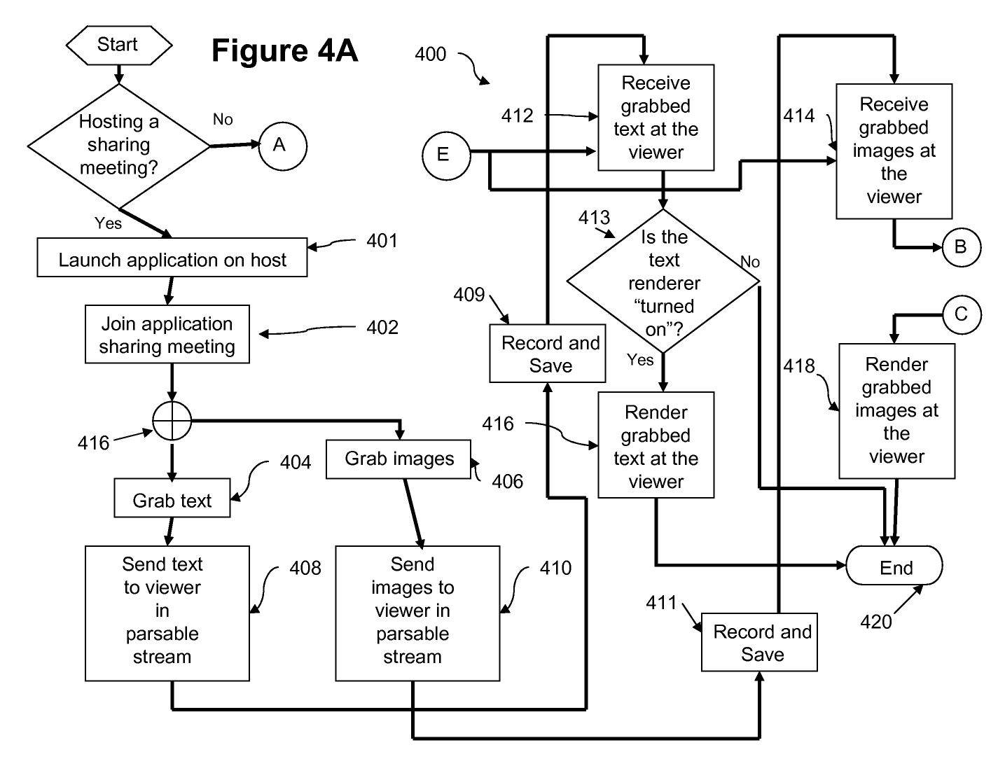

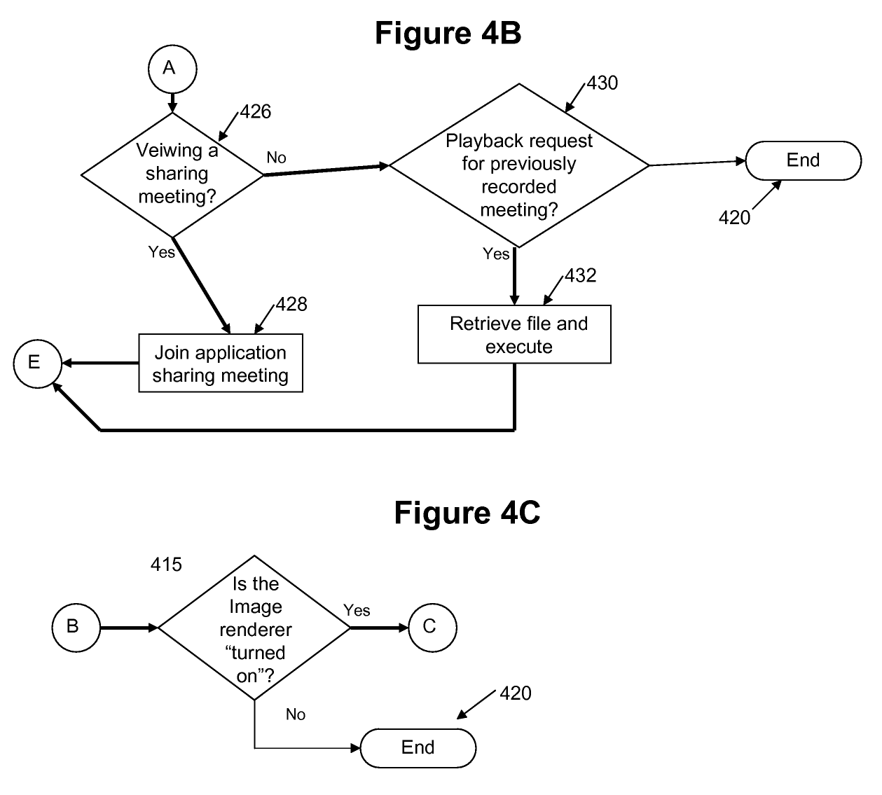

The method of the invention is shown in FIG. 4 at 400. At Start 422, the method moves to step 424 where it is determined whether the user is hosting a sharing meeting. If so, at 401, the application 122 to be shared is launched at the application sharing host 202 by the user doing the sharing. At 402, the user doing the sharing joins an application sharing meeting. At 404, the text 126 of the application 122 is grabbed by the text grabber plug-in 260. Alternatively, as denoted by OR function 416, at 406, the application 122 is grabbed, in image format, by the image grabber plug-in 262. At 408, text data 126 is sent to one or more application sharing viewers 206 by application sharing host controller 208 in a parsable stream. At 410, image data is sent to one or more application sharing viewers 206 by application sharing host controller 208 in a separate parsable stream. At 412, text data 126 is received by one or more application sharing viewers 206 by application sharing viewer controller 218. At 413, it determined whether the text renderer is “turned on” and, if not, the text rendering process ends at 420. If so, at 416, text data 126 is rendered by text renderer plug-in 266. At 414, image data is received by one or more application sharing viewers 206 by application sharing viewer controller 218. At 415, it determined whether the image renderer is “turned on” (denoted by “(B)” in FIG. 4C and, if not the image rendering process ends at 420. If so, at 418 ((C)), image data is rendered by image renderer plug-in 264.

If, at step 424, the user is not sharing a meeting, the method moves to step 426 (A) where it is determined whether the user is viewing a sharing meeting. If so, at 428, the user joins the sharing meeting and continues along the process at 428 discussed above shown by (E). If not, at 430, it is determined whether the user wishes to playback a previously recorded meeting and, if so, at 432, the previously recorded meeting file is retrieved and played for the user or, if not, the process ends at 420.

Because this invention separately handles a shared screen's text and images, viewers can employ a dual window interface displaying the shared images in one window and the shared text in another. The dual window UI could take many forms, such as that of a splitter window, a set of tabbed windows, or a set of MDI windows. This allows the user to choose between viewing one window, or both windows, so that a visually impaired user could zoom-in the bitmap based images, but still return to a text-only window to get a text-only format. The dual window UI could even be contained in a browser, allowing the text view to use a format such as HTML that is widely supported by screen readers.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A system for creating and managing a session for sharing, from a host to at least one viewer, in real time, an application, an entire desktop, or a portion of the desktop such as a frame, having both bit map images and text, the system having:
a sharing host for sharing bit map images and text with one or more sharing viewers;
one or more sharing viewers for viewing the shared bit map images and text;
an image grabber on the host for grabbing bit map images on the host;
a text grabber on the host for grabbing text on the host;
the sharing host sending the bit map images in an image stream and the text in a text stream separate from the image stream to the sharing viewer(s);
the sharing viewers receiving the image stream having the bit map images and the text stream having the text from the sharing host;
an image renderer on each sharing viewer for renderering bit map images on the sharing viewer; and
a text renderer on the sharing viewer for renderering text on the sharing viewer.

2. The system of claim 1 wherein further comprising a service provider interface (SPI) for interfacing with the text grabber and an SPI for interfacing with the image grabber.

3. The system of claim 1 further comprising a service provider interface (SPI) for interfacing with the text renderer and an SPI for interfacing with the image renderer.

4. The system of claim 1 wherein the text grabber, the image grabber, the text renderer and the image renderer each comprise one or more plug-ins for grabbing and rendering text and images respectively.

5. The system of claim 1 wherein the text renderer plug-in renders the text in audio format.

6. The system of claim 1 further comprising a sharing server for interfacing with the sharing host and the one or more sharing viewers and for managing the sharing session.

7. The system of claim 1 further comprising a recording component for recording the sharing session for playback some time later.

8. The system of claim 1 further comprising a text switch device and an image switch device, each controllable by the one or more sharing viewers such that the one or more sharing viewers may choose to “turn off” the shared text or the shared images such that sharing viewers do not see the shared text or the shared images.

9. A method for sharing an application, an entire desktop, or a portion of the desktop such as a frame, having both bit-map images and text comprising the steps of:
at the host, grabbing the text by a text grabber;
at the host, grabbing the bit-map images by an image grabber;
sending grabbed text in a parsable text stream from the host to at least one viewer in real time;
sending grabbed image in a separate parsable image stream from the host to at least one viewer in real time;
at the viewer, receiving the text stream and rendering the grabbed text; and/or
at the viewer, receiving the image stream and rendering the grabbed image.

10. The method of claim 9 wherein the text is rendered in audio format.

11. The method of claim 9 wherein the text is grabbed using a technology of at least one of voice to text, screen reading, string scraping, optical character reading, text mining, screen scraping or web scraping.

12. The method of claim 9 wherein the rendered text and the rendered image is rendered in a split screen wherein text data is rendered in one portion of the split screen and image data is rendered in another portion of the split screen.

13. The method of claim 9 wherein the rendered text and the rendered image is rendered in a tabbed window screen wherein the text data is rendered in one tabbed window and image data is rendered in another tabbed window.

14. The method of claim 9 further comprising the step of joining a sharing meeting at a sharing server.

15. The method of claim 9 wherein the system further has a text renderer switch and image renderer switch and further comprising the steps of determining whether the text renderer switch and/or the image renderer switch is “turned off” and, if so, skipping the text and/or the image rendering steps respectively.

16. The method of claim 9 further comprising the steps of recording the sharing session and storing the recorded sharing session in a file to be replayed some time later.

17. The method of claim 16 further comprising the steps of receiving a command to playback a previously recorded sharing session, retrieving the previously recorded sharing session file and playing the previously recorded sharing session file.

18. A computer program product in a computer readable medium for providing instructions steps to a computer system for sharing an application, an entire desktop, or a portion of the desktop such as a frame, having both bit-map images and text comprising the instruction steps of:
at the host, grabbing the text by a text grabber;
at the host, grabbing the bit-map images by an image grabber;
sending grabbed text in a parsable text stream from the host to at least one viewer in real time;
sending grabbed image in a separate parsable image stream from the host to at least one viewer in real time;
at the viewer, receiving the text stream and rendering the grabbed text; and/or
at the viewer, receiving the image stream and rendering the grabbed image.

19. The computer program of claim 18 wherein the text is rendered in audio format.

20. The computer program of claim 18 wherein the text is grabbed using a technology of at least one of voice to text, screen reading, string scraping, optical character reading, text mining, screen scraping or web scraping.

21. The computer program of claim 18 wherein the rendered text and the rendered image is rendered in a split screen wherein text data is rendered in one portion of the split screen and image data is rendered in another portion of the split screen.

22. The computer program of claim 18 wherein the rendered text and the rendered image is rendered in a tabbed window screen wherein the text data is rendered in one tabbed window and image data is rendered in another tabbed window.

23. The computer program of claim 18 further comprising the step of joining a sharing meeting at a sharing server.

24. The computer program of claim 18 wherein the system further has a text renderer switch and image renderer switch and further comprising the steps of determining whether the text renderer switch and/or the image renderer switch is “turned off” and, if so, skipping the text and/or the image rendering steps respectively.

25. The computer program of claim 18 further comprising the steps of recording the sharing session and storing the recorded sharing session in a file to be replayed some time later.

26. The computer program of claim 25 further comprising the steps of receiving a command to playback a previously recorded sharing session, retrieving the previously recorded sharing session file and playing the previously recorded sharing session file.
